(19) United States
(12) Patent Application Publication
(10) Pub. No.: US 2009/0301287 A1
(43) Pub. Date: Dec. 10, 2009

(54) Gallery of Ideas

(75) Inventors: David Harvey, Lodon (GB); Daniel Spreadbury, Middlesex (GB); James Larcombe, London (GB); Graham Westlake, Hertfordshire (GB); Jonathan Finn, London (GB)

Correspondence Address: OLIVER STRIMPEL, PATENT COUNSEL;AVID TECHNOLOGY, INC., ONE PARK WEST, TEWKSBURY, MA, 01876, US

(73) Assignee: Avid Technology, Inc.

(21) Appl. No.: 12/135,109

(22) Filed: Jun. 6, 2008

(51) Int. Cl. G10H 7/00

(52) U.S. Cl. 84/609

(57) ABSTRACT

Systems and methods for using musical data are provided. In one implementation, a method is provided that includes receiving input selecting a musical phrase including musical data. A copy of the musical phrase is created and persistently stored. An input is received selecting a destination location in a musical score. The copy of the persistently stored musical phrase is placed into the musical score at the selected location.

### TECHNICAL FIELD

This subject matter is generally related to musical composition.

### BACKGROUND

Music notation applications can allow a user to create and edit a musical composition represented on a musical score using conventional music notation. Music notation software can also be used to print the musical score (e.g., for use in a rehearsal or a performance).

A musical composition can be any length and can be composed for one or more instruments. When composing a musical composition, a composer will often find inspiration in the rhythms or melodies of her own prior musical compositions or in the musical compositions of other composers. Often these rhythms and melodies of other musical compositions will aid a composer in completing her own musical composition (e.g., when the composer has run out of compositional ideas).

### SUMMARY

A musical idea is a fragment of a musical composition that includes associated musical data (e.g., musical notes), metadata, and graphical data. Musical ideas can be created and persistently stored along with associated metadata and graphical data. Musical ideas can be persistently stored within a musical composition or in a library apart from a musical composition. Musical ideas stored within a composition can be used repeatedly within the same musical composition by the same composer. Musical ideas stored in a library apart from the musical composition can be used in different musical compositions by different composers. Musical ideas stored within a composition or within a library can provide a reusable resource of compositional material for composers. Additionally, musical ideas can be used by educators to assist students with music notation and inspire students to experiment with compositional techniques. Metadata persistently stored with a musical idea can allow the musical idea to be searchable (e.g., in an index). Additionally, the metadata can facilitate changes (e.g., transpositions) to the musical idea when the musical idea is used (e.g., placed in a musical score). Graphical data persistently stored with a musical idea can allow the musical idea to be displayed on a graphical user interface.

In general, in one aspect, a computer implemented method is provided. The computer implemented method includes receiving input selecting a musical phrase including musical data. A copy of the musical phrase is created and persistently stored. An input is received selecting a destination location in a musical score. The copy of the persistently stored musical phrase is placed into the musical score at the selected location.

In general, in another aspect, a computer implemented method is provided. The computer implemented method includes receiving input selecting a musical phrase including musical data from a first musical score. A copy of the musical phrase is created and persistently stored. An input is received selecting a destination location in a second musical score. The copy of the persistently stored musical phrase is placed into the second musical score at the selected location in the second musical score.

In general, in yet another aspect, a computer-readable medium is provided. Instructions are stored on the computer readable medium The instructions can be executed by a processor to cause the processor to perform operations comprising generating musical data. The musical data is persistently stored. The musical data includes a musical phrase and associated metadata. When the musical data is selected, the musical data is capable of being incorporated into a musical score.

Other embodiments of this aspect include corresponding systems, apparatus, and computer program products.

These and other embodiments can optionally include one or more of the following features. The copy of the musical phrase can be persistently stored in the musical score. The copy of the musical phrase can be persistently stored in a library accessible from more than one distinct musical score. The copy of the musical phrase can be viewable in a window apart from the musical score. Placing the copy of the musical phrase into the musical score can include automatically transposing the copy of the musical phrase. Placing the copy of the musical phrase into the musical score can include automatically adjusting the meter of the copy of the musical phrase.

Metadata and graphical data associated with the musical phrase can be captured and persistently stored at a source location. Metadata can be used to conform the musical phrase to a destination location. Graphical data can be used to display the musical phrase at the destination location. Metadata can include one or more types of information including a name, a key signature, a time signature, an identifier of one or more instruments, and one or more tags.

Placing the copy of the musical phrase into the musical score can include replacing one or more musical notes in the musical score with the copy of the musical phrase. Selecting a musical phrase can include selecting a group of notes for a particular instrument. Placing the copy of the musical phrase into the musical score can include changing a staff in the location in the musical score to correspond to the particular instrument.

The details of one or more embodiments of the invention are set forth in the accompanying drawings and the description below. Other features, aspects, and advantages of the invention will become apparent from the description, the drawings, and the claims.

### BRIEF DESCRIPTION OF DRAWINGS

FIG. 1 is a flowchart of an example method for creating and using a musical idea.

FIG. 2 shows a screenshot illustrating an example creation of a musical idea.

FIG. 3 shows a screenshot illustrating an example use of a musical idea.

FIG. 4 shows a screenshot illustrating an example search of musical ideas.

FIG. 5 shows a screenshot illustrating an example view of a musical idea and associated metadata.

FIG. 6 shows a screenshot illustrating an example view of a user interface for editing the metadata associated with a musical idea.

FIG. 7 shows a screenshot illustrating an example view for editing a musical idea.

FIG. 8 shows a screenshot illustrating an example use of the musical idea depicted in FIG. 5.

FIG. 9 shows a screenshot illustrating another example view of a musical idea and associated metadata in a “detailed view” of the ideas window.

FIG. 10 shows a screenshot illustrating an example use of the musical idea depicted in FIG. 9.

FIG. 11 shows a screenshot illustrating another example use of a musical idea.

FIG. 12 is a flowchart of an example process for selecting and using a musical idea.

FIG. 13 shows a schematic diagram of an example computer system.

Like reference numbers and designations in the various drawings indicate like elements.

### DETAILED DESCRIPTION

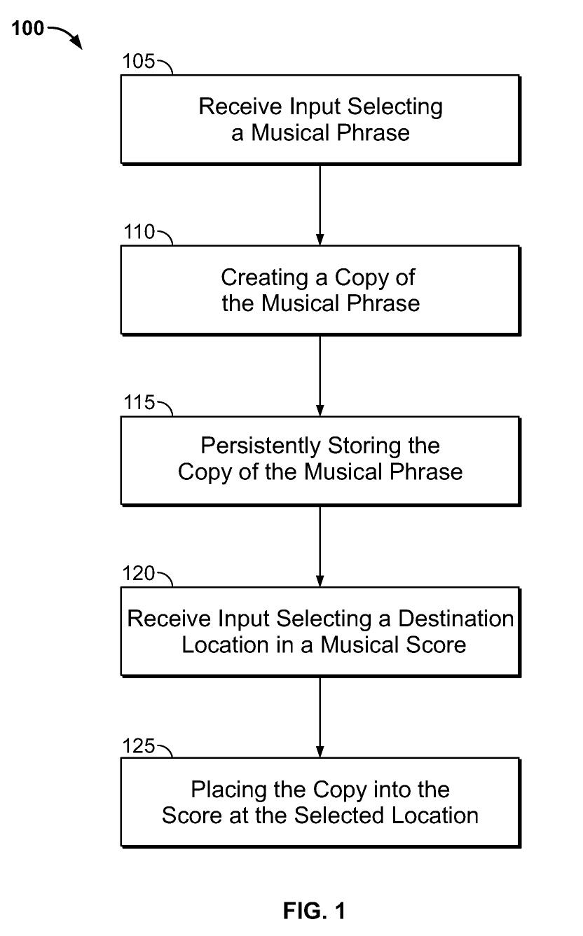

FIG. 1 shows a flowchart of an example method 100 for creating and using a musical idea. For convenience, the method 100 will be described with reference to a system that performs the method 100. The system (e.g., a computer and an application), receives 105 a selection of a musical phrase from a user (e.g., using a user interface). The musical data from the selected musical phrase can be used to create one or more musical ideas.

A musical idea can include several types of data including musical data (e.g., musical objects in a musical score), metadata (e.g., data derived from the musical data), and graphical data (e.g., a visual representation of the musical idea). In some implementations, the musical idea is self-contained, having no dependency on the score the idea was derived from. In some implementations, the musical idea is combined and persistently stored with one or more other musical ideas.

Musical data associated with a musical idea can include one or more musical notes (e.g., a musical phrase) written in a particular key. A key is an implied adherence, in a particular musical phrase, to the notes of any given type of scale, (e.g., major, minor, pentatonic, etc.) where one note is recognized as the controlling note, key note, or tonic. For example, when a musical phrase is written in the key of C, then C is the harmonic center or tonic of the musical phrase. A musical phrase written in the key of C Major implies a musical phrase harmonically centered around the note C and making use of a major scale whose first note, or tonic, is C.

A musical scale is an ordered set of notes typically used in a key. A musical scale includes a series of single notes progressing up or down stepwise, where the first note and the last note, referred to as primary notes, can be similar notes separated by an ordered series of musical intervals (e.g., an octave, or twelve semi tones). The series of notes, along with the key or tonic, define the pitches of the scale. The smallest distance (or interval) between two notes in a scale is the semi tome (or half step). An interval having two semi tones is equivalent to a whole tone (or whole step).

Distances between each pair of notes in a scale can be predetermined based on both the key and the type of scale being used. For example, in the key of C Major, there are no sharps (e.g., notes which have to be adjusted up a semi tone) or flats (e.g., notes which have to be adjusted down a semi tone). In C Major, C is tonic, and the musical notes in a C Major scale are C, D, E, F, G, A, B, C. In contrast, in the key of c natural minor, there are three flat notes (i.e., Bb, Eb, and Ab). Thus, the musical notes in a c natural minor scale are C, D, Eb, F, G, Ab, Bb, C.

A key can be represented by a key signature. In musical notation, a key signature is a series of symbols representing sharps and flats. For example, the key of C Major includes no sharps or flats, thus the key signature for C Major will include no sharps or flats. In contrast, the key of c minor includes three flats, thus the key signature of c minor will include three flats (i.e., Bb, Eb, and Ab). A key signature is not definitive of every note in a musical phrase, as different accidentals (e.g., a “natural” symbol) can be used to alter notes affected by the accidentals (e.g., sharps and flats) in the key signature.

A key signature can be placed on a staff. A staff is a graph including at least one line for indicating musical notation. In some implementations, a staff includes a plurality of lines and spaces for indicating musical notation. A staff can be used to display a visual representation of a musical note with respect to time or rhythm.

A key signature placed on a staff can initially designate notes that are to be consistently played sharp (e.g., one semitone higher than the equivalent natural notes) or flat (e.g., one semitone lower than the equivalent natural notes), unless otherwise altered with another accidental (e.g., a “natural” symbol).

Although key signatures can appear in other parts of a musical score, key signatures are generally written after a clef at the beginning of a line of musical notation. A clef is a musical symbol used to indicate the pitch of written musical notes. When placed on a line at the beginning of a staff, a clef can indicate the name and pitch of the notes on that line. The line including the staff can serve as a reference point by which the names of the notes on any other line or space of the staff can be determined. For example, a “treble” clef can be placed on the second line of a staff, indicating that the second line will represent the musical note “G”. The other lines and spaces on the staff are determined according to the placement of the treble clef. For example, the first line on the staff is an “E”, the first space below the second line on the staff is an “F”, the first space above the second line on the staff is an “A”, etc. Other clefs can be placed on the staff to indicate pitches, for example, a bass clef.

A musical phrase can be written in any key. A musical phrase can be written for one or more musical instruments. A musical instrument can be configured to play in a particular key using a particular clef and within a particular range of musical notes (or pitches). A musical instrument configured to play within a certain range of musical notes can usually generate notes outside of the range. However, notes outside the range sometimes sound unpleasant. Thus, musical notes written for a specific range on an instrument and played on a different instrument are usually transposed to accommodate the range of the different instrument. For example, a musical phrase written for an oboe but played on a violoncello could be transposed down two octaves (i.e., 24 semi-tones) to accommodate the range of the violoncello.

A musical instrument configured to play in a specific key can perform musical phrases written in other keys. For example, a musical phrase written in C Major can be performed on a Bb trumpet. In this example, the musical phrase written in C Major could be re-written or transposed (i.e., up a whole tone) to accommodate the disparity between the keys. Additionally, the key signature could be modified (i.e., changed from C Major to D Major by adding two sharps to the key signature), to accommodate the new musical phrase. A musical phrase can be written without a key signature (e.g., when a musical phrase is written for an un-pitched percussion instrument).

A musical phrase can have one or more time signatures. A time signature can be used to specify how many beats are in a measure and what note value constitutes one beat. A measure (or bar) is a segment of time defined as a given number of beats for a given duration. For example, a musical phrase including the time signature 4/4 will have four beats to the measure and a quarter note will constitute one beat. In another example, a musical phrase including the time signature 3/8 will have three beats to the measure and an eighth note will constitute one beat. A musical phrase can encompass one or more measures. In a measure, a note can represent a portion of a single beat, a single beat or an amount greater than a single beat (e.g., several beats). Measures in musical scores are often numbered beginning with the first measure in a musical score.

A musical phrase can include one or more tempos (e.g., written at the start of a piece of music), that can be used to determine the speed or pace at which the musical phrase should be played. A tempo is usually indicated in beats per minute (bpm). For example, if the tempo for a musical phrase is [symbol] =120 bpm, then the eighth note is specified as the beat, and the marking indicates that a 120 eighth note beats should be played per minute.

A musical phrase can include one or more dynamics or nuance markings. The use of dynamics in musical notation can refer to the volume of a sound or note (e.g., the use of a “p” or “piano” marking in a musical score is an indication that the note should be played softly). Dynamics can also refer to a style for playing the note (e.g., staccato, legato, etc.). Musical dynamics are stylistic suggestive notations. Musical dynamics do not define the only way in which a note or a group of notes can be played.

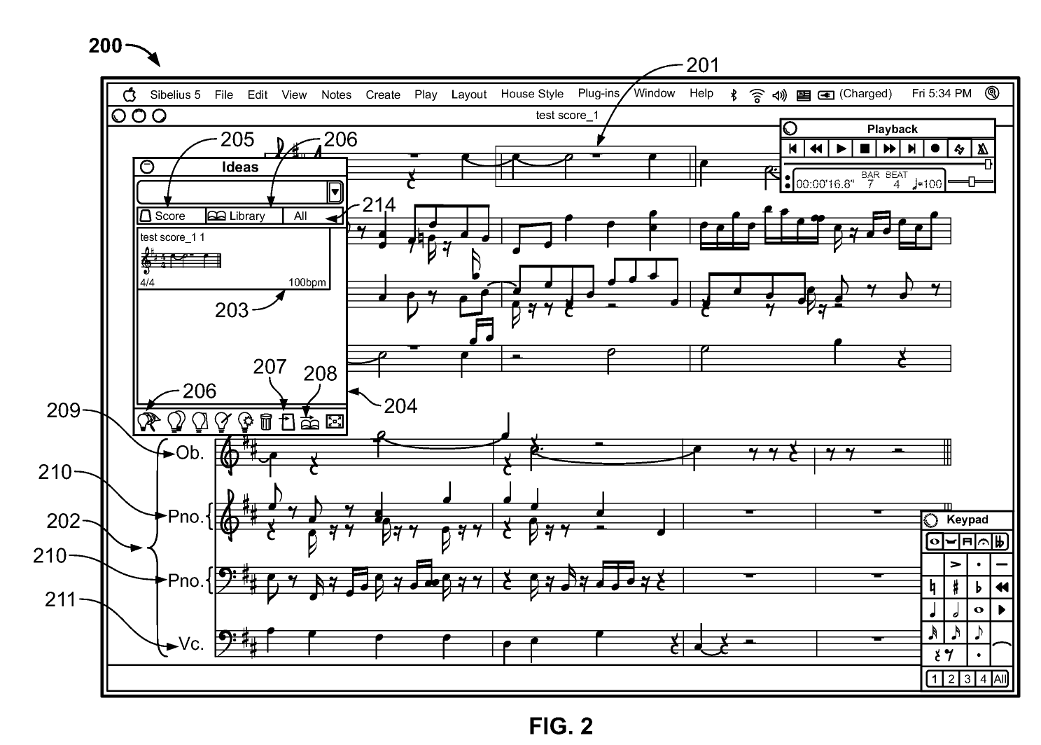

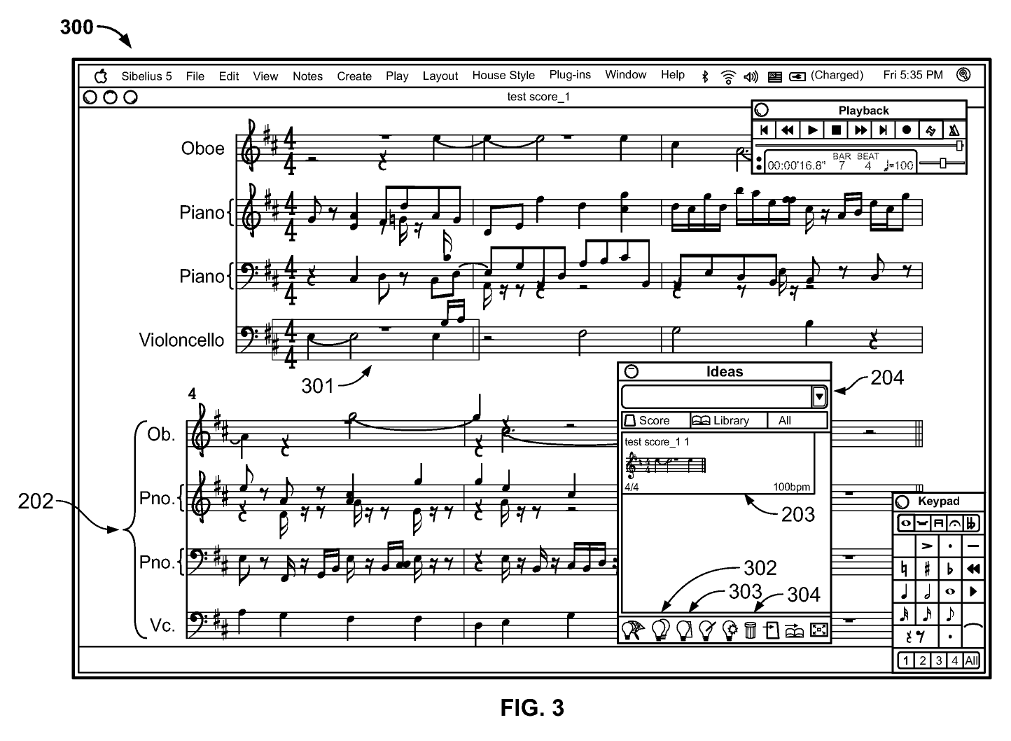

Referring again to FIG. 1, after the system receives 105 a selection of a musical phrase, the system can automatically create 110 a musical idea using the musical data in the selected musical phrase. The musical idea can be persistently stored 115. Selecting the musical idea and selecting 120 a location in a musical score can cause the system to place 125 a copy of the musical idea into the selected location in the musical score. This will be discussed in greater detail with reference to FIGS. 2 and 3.

FIG. 2 shows a screenshot 200 illustrating an example creation of a musical idea 203. A musical phrase 201 can be depicted graphically in a user interface as part of a musical score 202. Musical score 202 includes three musical instruments, namely, an oboe 209, a piano 210, and a violoncello 211. The musical notes for each musical instrument are written on at least one staff. Each staff includes a clef, a key signature, and a time signature. For example, the musical notes for the violoncello 211 are written on a single 5-line staff including a bass clef 212, a key signature (D Major) 213, and a time signature (4/4) (not shown).

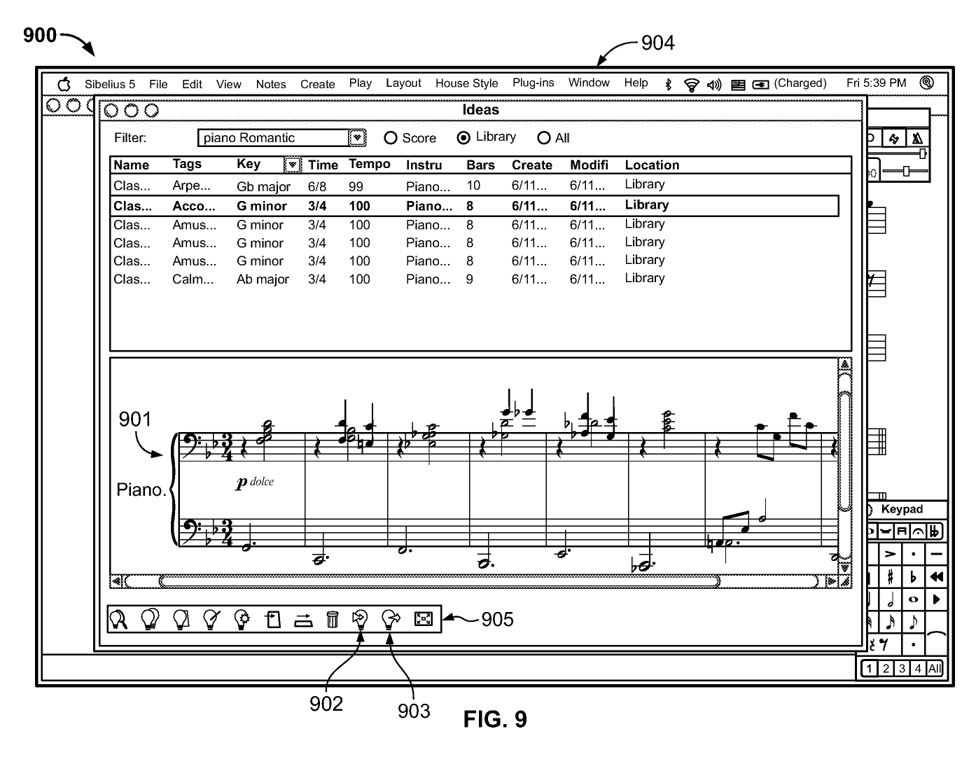

The graphical data associated with the musical phrase 201 can include a bitmap representation in Portable Network Graphic (PNG format) of the musical phrase. In one implementation, the bitmap representation of the musical phrase can be displayed in a “compact view” in a separate window (e.g., “ideas” window 204). In this implementation, the bitmap representation can depict up to two bars of the musical phrase, drawn at a reduced scale (e.g., 50%), and displayed in a panoramic view. Other implementations are possible (e.g., a “detailed view” window of the musical phrase can be displayed), and will be discussed in reference to FIG. 9.

In some implementations, a musical idea 203 can be created by selecting a particular musical phrase (e.g., the musical phrase 201) directly from a musical score 202. In some implementations, the system can receive input indicative of a user selection. Based on the received user input, the system can generate the data structure (e.g., musical idea 203) representing the musical phrase 201. For example, using an input device, a user can select an arbitrary amount of musical notes from one or more measures of the musical score. In some implementations, the musical phrase 201 is created by selecting the musical phrase 201 and then selecting a capture icon 206. Capturing the musical phrase 201 can cause the system to create and persistently store a copy of the musical data (e.g., the notes) in the musical phrase 201 along with any associated metadata and graphical data associated with the musical phrase 201.

The musical idea 203 can include all of the musical data, metadata, and graphical data associated with the musical phrase 201. For example, the musical idea 203 can include musical data corresponding to the musical notes in the musical phrase 201. The musical data can include data about one or more instruments used to create the musical phrase 201, data corresponding to a key signature, a time signature, or a tempo marking of the musical phrase 201, and other related data such as style type data (e.g., note head types, text styles, staff types, symbol styles, or line styles) and dynamics or nuance data (e.g., indications of how the musical data should be interpreted).

In some implementations, the system can perform a clipboard operation on musical data in the musical idea 203. In these implementations, data corresponding to the musical idea 203 is streamed to a file and persistently stored. Musical data can be stored in a hierarchical structure (e.g., a tree) that describes the items (e.g., the notes) and corresponding styles included in the musical idea 203. For example, a note is dependent on a text style, because the font character used to display the note is saved as a text style. Similarly, a line may be dependent on a symbol (e.g., for an octave line), and that symbol will also be dependent on a text style. In some implementations, the system can traverse the hierarchical representation to ensure that all the styles required by the items in the musical idea 203 are persistently stored.

The musical idea 203 can also include metadata such as a date and time when the musical phrase 201 was created, a date and time when the musical phrase 201 was last modified (if necessary), a name for the musical phrase 201, a key signature for the musical phrase 201, a time signature for the musical phrase 201, a tempo for the musical phrase 201, the number of measures in the musical phrase 201, and one or more tags or keywords describing one or more aspects or characteristics corresponding to the musical phrase 201. The metadata is created when the musical idea 203 is created. Additionally, the musical idea 203 can include graphical data for creating a graphical representation or preview of the musical idea 203. For example, when an idea is captured, graphical data is created and saved as a PNG.

The musical idea 203 can be persistently stored 115. In some implementations, the musical idea 203 is persistently stored within the musical score 202, in a portion of memory designated for musical ideas created within the musical score 202. For example, the musical idea 203 can be persistently stored within the musical score 202 by selecting an “add to score ideas” icon 207 in the “ideas” window 204. In these implementations, each time the musical score 202 is opened, the musical data, associated metadata, and associated graphical data corresponding to musical idea 203 stored within the musical score 202 are available for use within the musical score 202. Persistently storing a musical idea 203 within a musical score does not automatically make that musical idea available for use in other musical scores.

In some other implementations, the musical idea 203 can be persistently stored in a library apart from the musical score 202 where the musical idea 203 was created. For example, the musical idea 203 can be persistently stored within a library by selecting an “add to library” icon 208 in the ideas window 204. In these implementations, each time any musical score is opened, the musical data, metadata, and graphical data stored within the library, and corresponding to musical idea 203 are available for use in that particular musical score. In some implementations, the musical idea 203 is persistently stored within both the musical score 202 where the musical idea 203 was created and within a library apart from the musical score 202 where the musical idea 203 was created.

In some implementations, musical ideas can be collected together and placed into a musical idea database file. In some implementations, a musical idea database file is stored on a local hard disk, and musical ideas are imported and exported from the musical idea database file as needed.

The musical idea 203 can be viewed in a source location window (e.g., the ideas window 204). Ideas window 204 can represent a “compact” view of the musical idea 203. In some implementations, a “detailed” view of the musical ideas can be displayed. The detailed view will be discussed with respect to FIG. 9.

The ideas window 204 can include other musical ideas in addition to the musical idea 203. For example, musical ideas created and persistently stored in the musical score 202 can be viewed by selecting a score button 205 in the ideas window 204. In another example, musical ideas created in other musical scores and persistently stored in a library apart from any specific musical score can be viewed by selecting the library button 206. In yet another example, copies of all musical ideas (e.g., musical ideas created in any musical score and persistently stored within the score where they were created or musical ideas persistently stored within a library apart from the score where they were created), can be viewed by selecting an all button 214.

In some implementations, when a musical idea 203 is created, the system can dynamically generate audio data corresponding to the musical idea (e.g., as a MIDI performance of the musical data associated with the musical idea 203. In these implementations, selecting the musical idea 203 within the ideas window 204 causes the audio data corresponding to the musical idea 203 to be played for the user. For example, audio data corresponding to the musical idea 203 can be heard while a left mouse button is depressed. Releasing the left mouse button could then cause the audio data corresponding to the musical idea 203 to stop playing.

In another example, clicking or selecting the musical idea once can cause the system to play the audio data, and clicking or selecting the musical idea a second time can cause the system to stop playing the audio data. In another example, clicking or selecting the musical idea once can cause the system to play the entire segment of audio data once and stop, or multiple times (e.g., in a continuous loop) until an input is received causing the system to stop playing the audio data. In yet another example, clicking or selecting the musical idea can cause the system to play a predetermined portion of the audio data (e.g., when the musical idea is greater than a certain number of measures).

In some implementations, audio data corresponding to a musical idea can be persistently stored as part of the musical idea 203. In these implementations, the system can use audio data persistently stored with a musical idea to play an audio version of the musical idea incorporated into a musical score.

FIG. 3 shows a screenshot 300 illustrating an example use of the musical idea 203. The screenshot 300 includes the musical score 202 and the ideas window 204 including a the musical idea 203. The user can manipulate the musical idea 203 within the ideas window 204. For example, after the musical idea 203 is selected within the ideas window 204, the musical idea 203 can be copied by selecting a “copy” icon 302 in the ideas window 204 (e.g., to form a second musical idea in the ideas window 204 that is a copy of the musical idea 203). In another example, after the musical idea 203 is selected, the musical idea 203 can be deleted by selecting a “delete” icon 304 in the ideas window 204 (e.g., to remove the musical idea 203 from the ideas window 204). Additionally, the musical idea 203 can be used again within the musical score 202 (e.g., if the musical idea 203 has been stored in the musical score 202 or in a library) or within another musical score (e.g., if the musical idea 203 has been stored in the library). After the musical idea 203 is selected, a location 301 in the musical score 202 can be selected 120 (automatically or through user input). The musical idea 203 can be placed 125 into the selected location 301 (e.g., by selecting a “paste” icon 303 in the ideas window 204). In some implementations, a musical idea can be placed within a musical score by “dragging” the musical idea from the musical ideas window 204 to a location in the musical score and “dropping” the musical idea into the musical score at the location.

A musical idea can be placed within the same musical score multiple times. For example, multiple copies of a musical idea can be placed adjacently to one another within a musical score. Alternatively, multiple copies of a musical idea can be placed throughout the score at non-adjacent locations. In some implementations, the musical idea can be separated into multiple portions. One or more of these portions of the musical idea can be placed at different locations throughout a musical score.

In the example shown, the musical idea 203 was created by capturing a musical phrase 201 from the second measure of an oboe part (as shown in FIG. 2). An oboe interprets musical notation using the treble clef (also referred to as a “G clef”). The musical idea 203 was pasted into a violoncello part. A violoncello interprets musical notation using an “F” or bass clef Thus, when the musical idea 203 is pasted into the violoncello part, the metadata associated with the musical phrase 201 is used to transpose the musical idea 203 down two octaves to conform to the requirements of the different instrument, the different clef, and the different range resulting in the musical phrase 301.

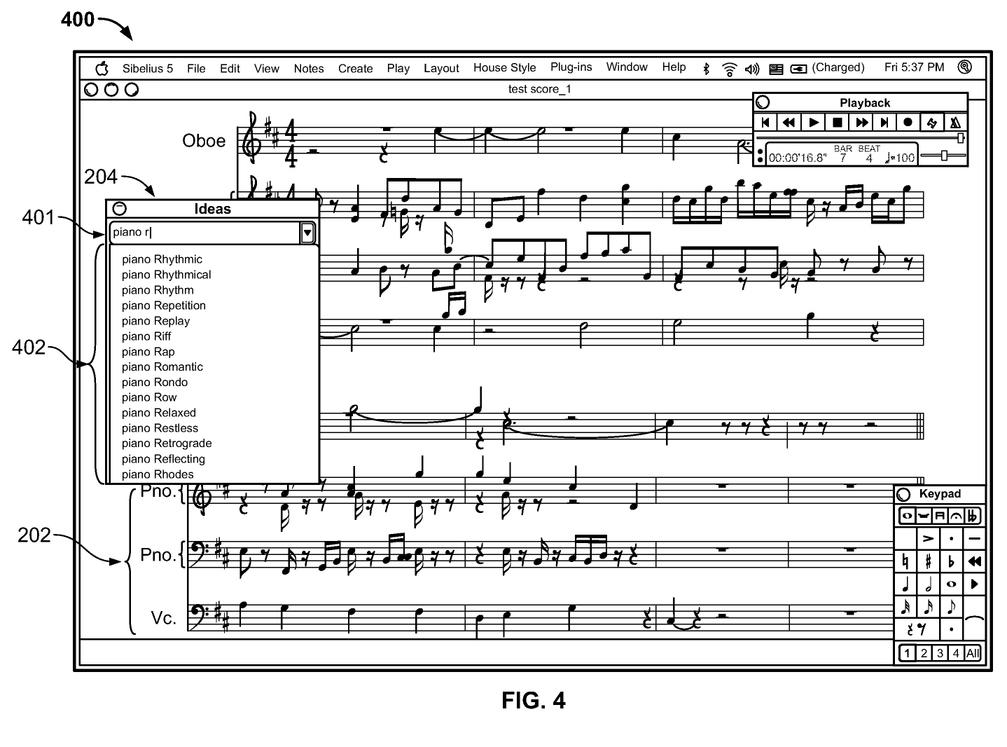

FIG. 4 shows a screenshot 400 illustrating an example search of musical ideas. In some implementations, musical ideas are filtered and searched using a text box 401 presented in the ideas window 204. For example, keywords entered into the text box 401 can be used to filter and search musical ideas persistently stored within the musical score 202, within a library, or within both the musical score 202 and a library. In some implementations, as text is entered into the text box 401, the system identifies keywords and presents a list of one or more idea descriptions 402 associated with musical ideas matching (e.g., completely or partially) the input keyword.

For example, the system can search the metadata associated with each musical idea stored within the system to identify keywords used to describe the persistently stored musical ideas. In the example shown, entering the letters “piano r” into text box 401 can cause the system to identify a list of multiple musical idea descriptions 402 associated with metadata including at least the keyword “piano” and a second keyword beginning with the letter “r” (e.g., piano Romantic). A user can select a musical idea description (e.g., piano Romantic), corresponding to a particular musical idea, from the list of one or more musical idea descriptions 402.

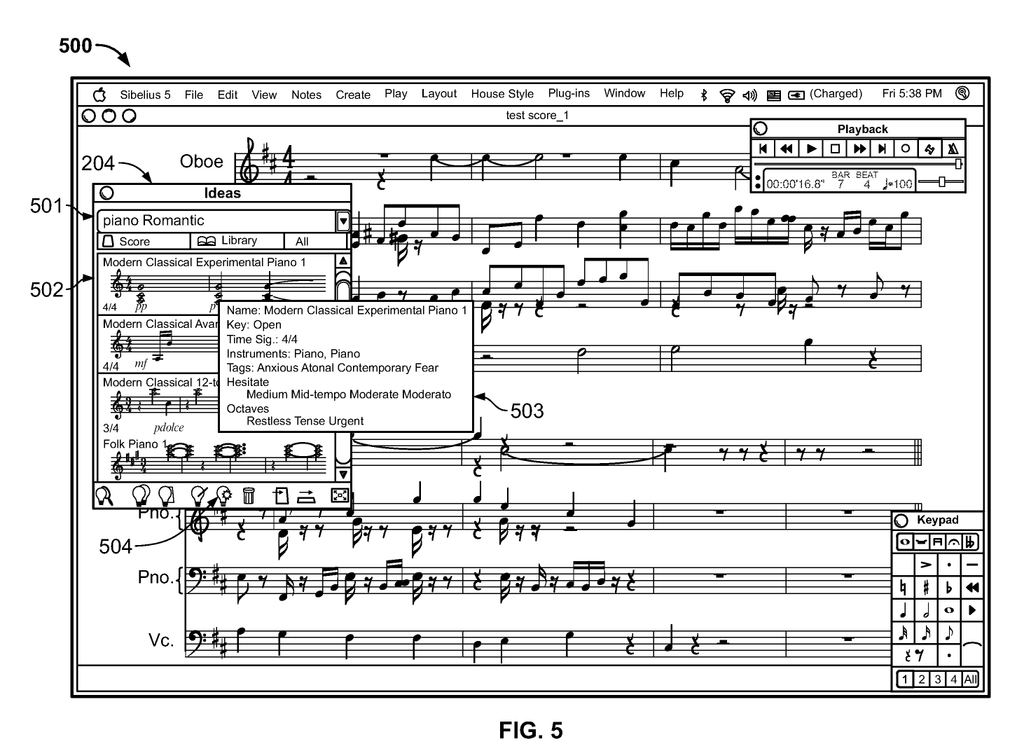

FIG. 5 shows a screenshot 500 illustrating an example view of a musical idea 502 and associated metadata 503. After a user has selected a musical idea description (e.g., piano Romantic 501), the system can present a viewable list of multiple musical ideas (e.g., using graphical data associated with the respective musical ideas) that include the keywords piano and Romantic in their respective metadata. In some implementations the ideas window 204 can include multiple different ideas (e.g., from the musical score where the musical idea was crated or from a library of musical ideas). In the example shown, several ideas are displayed in the ideas window 204. In some implementations, additional ideas can be displayed by “scrolling” down the ideas window 204. A particular idea can be selected in the manner described above with respect to FIGS. 2 and 3.

In some implementations, the list of multiple musical ideas is presented based on an order of relevance. For example, musical ideas having the keyword(s) appearing in the name metadata could be presented first. Musical ideas having the keyword(s) appear in the tags metadata could be presented second. Musical ideas having the keyword(s) appear in instrument names metadata could be presented third. Musical ideas having the keyword(s) appear in any other metadata (e.g., keywords “C Major” appearing in “key signature” metadata) could be presented last.

In some implementations, the user can view metadata associated with each musical idea (e.g., by hovering a mouse over the musical idea or by selecting a particular musical idea). The system can use the graphical data associated with the musical idea to present an idea information window 503 to the user. In the example shown, the metadata associated with the “Modern Classical Experimental Piano 1” musical idea 502 is displayed in the idea information window 503. The metadata in the idea information window 503 includes name metadata (e.g., Modern Classical Experimental Piano 1), key metadata (e.g., open or “no specified key”), time signature metadata (e.g., 4/4), instruments used metadata (e.g., piano, piano), and tags or keyword metadata (e.g., Anxious, Atonal, Contemporary, Fear, Hesitate, Medium, Mid-tempo, Moderate, Moderato, Octaves, Restless, Tense, and Urgent).

Metadata associated with a musical idea can be generated automatically when a musical idea is created. For example, when a musical idea is created, the system can create metadata based upon the selected musical phrase. Additionally, the system can infer metadata from the musical score where the selected musical phrase originates. For example, the system can infer information about the time signature for the musical idea by examining the most recent occurrence of a time signature in the musical score with respect to the location of the selected musical phrase. In another example, the system can infer information about the instrument used in the musical idea by examining the last instrument change in the musical score with respect to the location of the selected musical phrase.

Metadata associated with a musical idea can also be generated based on received user input. For example, the metadata associated with a musical idea (e.g., the “Modem Classical Experimental Piano 1” musical idea 502), can be edited. In some implementations, in order to edit metadata associated with a musical idea, the user selects a musical idea (e.g., the “Modem Classical Experimental Piano 1” musical idea 502) and then select an “Edit Idea Info” icon 504. Selecting the “Edit Idea Info” icon 504 can cause the system to present a corresponding “Edit Idea Info” window displaying a user interface for editing the idea information 503 associated with the musical idea 502.

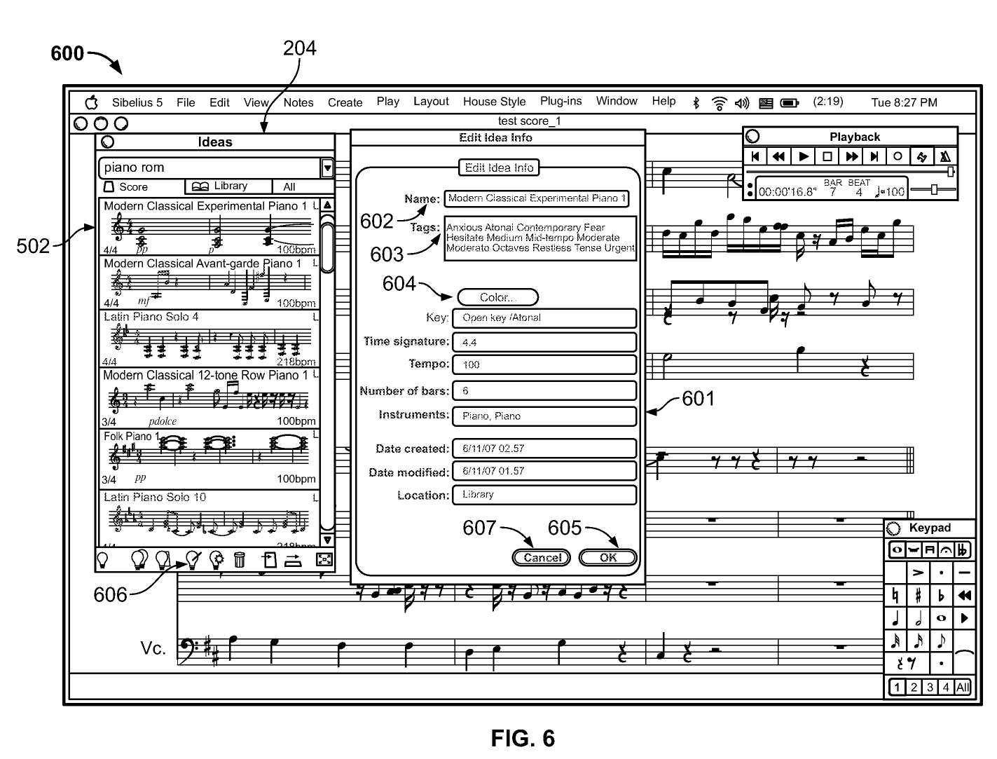

FIG. 6 shows a screenshot 600 illustrating an example view of a user interface for editing the idea information 503 associated with the musical idea 502 of FIG. 5. The user interface can be displayed in a separate window (e.g., an Edit Idea Info window 601) apart from the ideas window 204. The Edit Idea Info window 601 can include one or more text boxes for entering data associated with the musical idea 502. In the example shown, the Edit Idea Info window 601 includes a name text box 602 for editing the name metadata associated with the musical idea 502 and a tag text box 603 for editing the keyword metadata associated with the musical idea 502. The Edit Idea Info window 601 can display other metadata information that can not be edited using the Edit Idea Info window 601 (e.g., time signature, date created, etc.).

In some implementations, the Edit Idea Info window 601 includes a color button 604. Selecting the color button 604 can cause the system to display a selection of colors. A color from the selection of colors can be chosen by a user. The chosen color can then be applied to the background of the selected musical idea (e.g., musical idea 502), and the associated color metadata can be persistently stored with the musical idea. Adding or changing the background color (and color metadata associated with a musical idea) can help distinguish a musical idea from other musical ideas within a musical score (e.g., by making the musical idea visually identifiable). The Edit Idea Info window 601 also includes an OK button 605. Selecting the OK button 605 can cause the system to save changes to the metadata associated with the musical idea presented in the Edit Idea Info window 601. The Edit Idea Info window 601 also includes a cancel button 607. Selecting the cancel button 607 can cause the system to cancel any changes to the metadata made in the Edit Idea Info window 601.

Additionally, musical data associated with a musical idea (e.g., the “Modern Classical Experimental Piano 1” musical idea 502), can be edited. In some implementations, in order to edit musical data associated with a musical idea, the user selects the musical idea (the “Modern Classical Experimental Piano 1” musical idea 502) and then selects an “Edit” icon 606. Selecting the “Edit” icon 606 can cause the system to present a corresponding “Edit” window displaying a user interface for editing the musical data associated with the selected musical idea (e.g., musical idea 502).

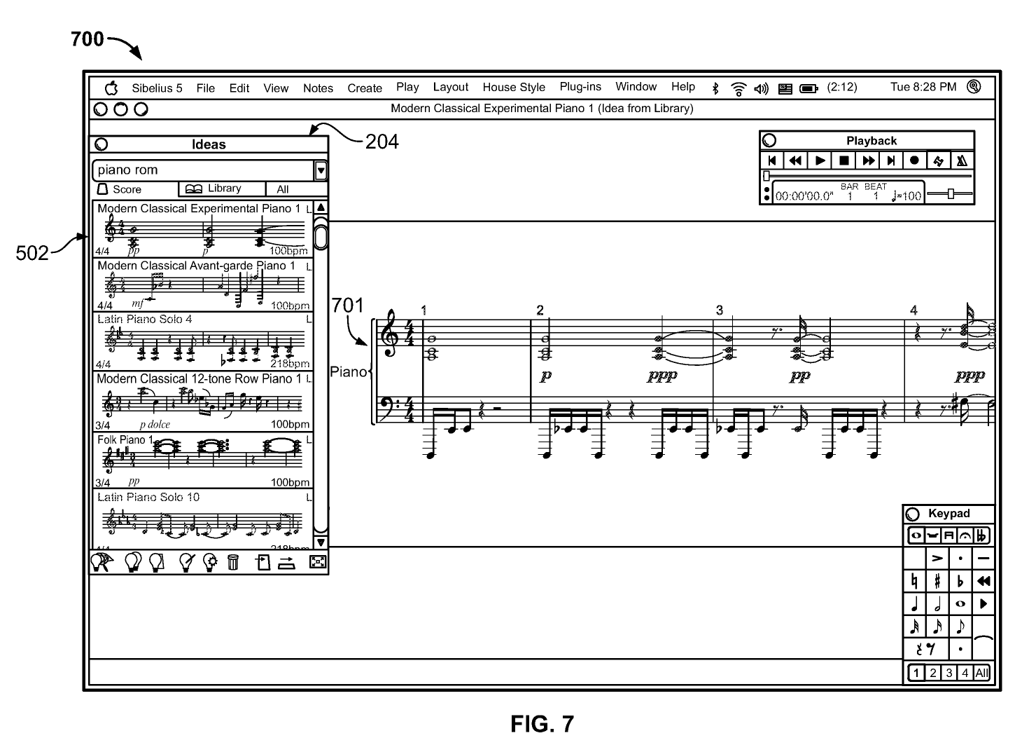

FIG. 7 shows a screenshot 700 illustrating an example view for editing a musical idea 502. The musical data can be displayed in a separate window apart from the ideas window 204. For example, the system can use the graphical data associated with the musical idea 502 to display a window including an enlarged version of the musical data associated with the musical idea 502. In the example shown, an enlarged version of the musical data associated with musical idea 502 is displayed as musical data 701. The musical data 701 is written for a piano, and includes a treble clef on one staff, a bass clef on another staff, a key signature (F Major), a time signature (4/4), musical notes, and musical dynamics markings (e.g., pp in the first measure).

A number of different aspects of the musical data 701 can be edited (e.g., a note can be changed, added, or deleted, or a dynamic can be changed, added, or deleted). Changes to the musical idea 502 can cause the system to perform automatic changes to metadata and graphical data associated with the musical data 701. Additionally, the audio data associated with musical data 701 can be adjusted to allow the system to play an edited version of musical data. Changes to the musical data 701 can be saved and persistently stored as the same musical idea 502, or as a new musical idea. Changes to the musical idea 701 can be saved and persistently stored within the musical score, within the library, or within both the musical score and the library.

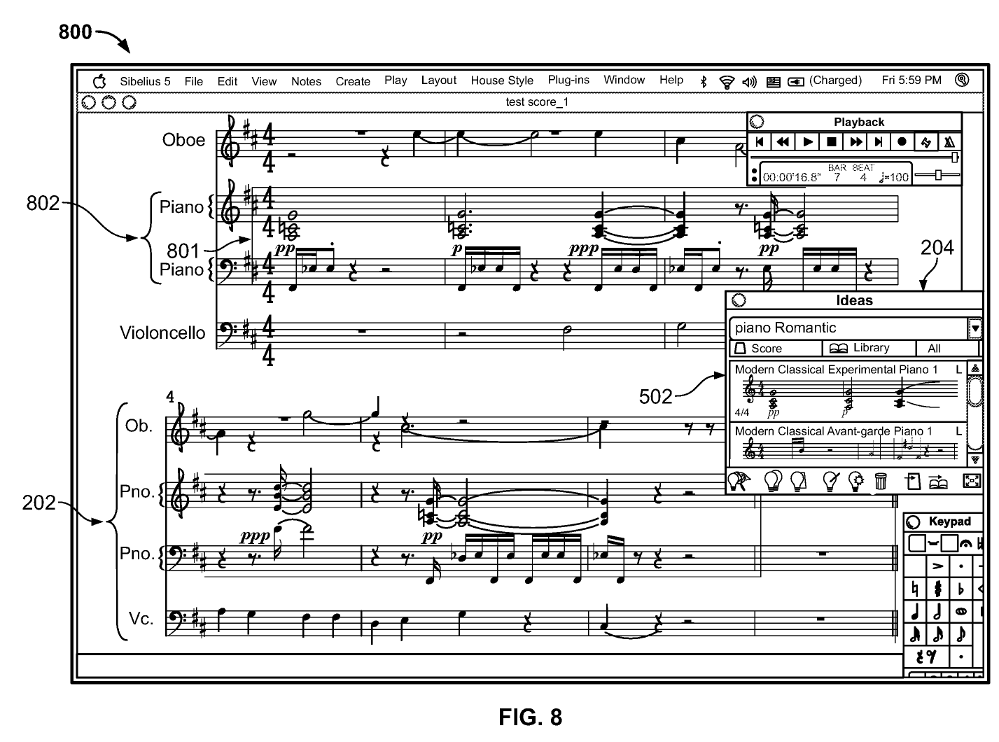

FIG. 8 shows a screenshot 800 illustrating an example use of the musical idea 502 depicted in FIG. 5. A musical idea can be used within a musical score (e.g., musical score 202). For example, a user can select the musical idea 502 and then select a destination location within the musical score 202 where the musical idea 502 should be placed. In the example shown, the user has chosen to place the musical idea 502 in the musical score 202 at a position beginning at the first beat of the first measure of the piano part 802. In this example, placing the musical idea 502 in the piano part 802 will cause the system to replace the existing content of the piano part modifying the piano part 802 to include the inserted musical idea 801 using the musical idea 502. Thus, the musical data, associated metadata, and associated graphical data of musical idea 502 replace the musical data, associated metadata, and associated graphical data of the piano part in musical score 202 where musical idea 502 is placed.

For example, if a musical idea is 10 measures, 10 measures of the musical score are replaced with the 10 measures of the musical idea. A musical idea can be placed at any location within a musical score. A musical idea can be placed at several locations within the same musical score. The same musical idea can be placed within a musical score in the same instrument part (e.g., in an oboe part), or within several instrument parts (e.g., within an oboe part and a piano part). Additionally, new audio data associated with musical idea 502 can be generated to replace the audio data generated for the piano part in musical score 202 where musical idea 502 is placed.

In the example shown, musical score 202 has the same time signature (e.g., 4/4) as musical idea 502, but musical score 202 has a different key signature (e.g., D Major) than the musical idea 502 (e.g., a minor). Thus, placing the musical idea 502 into the musical score 202 can cause the system to transpose the key signature of the musical idea 502 to conform to the key signature of the destination location within the musical score 202. In the example shown in FIG. 8, the system has transposed the key signature from a minor in the musical idea 502 to D Major in the musical score 202. In some implementations, the system can add accidentals to the musical idea 502 (e.g., “natural” symbols to occurrences of the note “C”), to maintain the harmonic structure of the musical idea 502 when it becomes part of the musical score 202.

In some implementations, after the musical idea 502 is placed into the musical score 202, a transform scale plug-in (not shown) can be used to transpose the musical data of the musical idea 502 into the key of the musical score 202 in which the musical idea 502 is placed. For example, after the musical idea 502 is placed into the musical score 202, the user can select the transform scale plug-in. Selecting the transform scale plug-in can cause the system to transpose the musical data in the musical idea 502 from a minor to D Major, the key of the musical score 202.

In some implementations, the musical data, associated metadata, and associated graphical data is used by the system to transform characteristics of one or more musical phrases within a musical score. For example, a musical idea can be used to transform the shape of a rhythm at the destination location in a musical score where the musical idea is placed. In another example, a musical idea can be used to transform an instrumental arrangement at the destination location in a musical score where the musical idea is placed. In yet another example, a portion of the musical idea (e.g., the metadata associated with the dynamics of the musical idea) can be used to transform the interpretation of the musical dynamics at the destination location in a musical score where the musical idea is placed. Transforming an instrumental arrangement can include using any process applied to the musical idea to transform one or more aspects of the destination location in a musical score where the musical idea is placed.

In some implementations, not every aspect of a musical idea is applied to the destination location in the musical score where it is placed. For example, when a musical idea includes both rhythmic and melodic data (e.g., a musical idea for an oboe), and the destination location only includes rhythmic data (e.g., a musical idea for a snare drum), then only the rhythmic data from the musical idea is applied at the destination location. In some implementations, only dynamics data is applied at the destination location. In some implementations, one or more aspects of a musical idea can be selectively applied using a customized command in a user interface. For example, a customized command can allow a user to select and apply particular aspects of a musical idea to a destination location. In some other implementations the entire musical idea is placed into the musical score. In some implementations only a portion of the musical idea is placed into the musical score.

The ideas window 204 can be implemented in other ways. For example, to view a detailed view of the ideas window, a user can select the “detailed ideas” icon 803 in the ideas window 204. Selecting the “detailed ideas” icon 803 causes the system to present a corresponding “detailed ideas” window displaying a user interface for editing the musical data associated with a musical idea.

FIG. 9 shows a screenshot 900 illustrating another example view of a musical idea 901 and associated metadata in a “detailed view” of the ideas window 204. A “detailed ideas” window 904 includes the same musical data, metadata, and graphical data depicted in the ideas window 204. The detailed ideas window 904 can additionally display the entire musical idea 901 (e.g., in a panoramic view). Additionally, the detailed ideas window 904 can include one or more columns for organizing and searching musical ideas using metadata associated with the musical ideas. In the example shown, the detailed ideas window 904 includes a name column, a tags column, a key column, a time column, and instrument column, a bars (or measure) column, a create column, a modify column, and a location column. Selecting a header for a particular column can sort the metadata within that column. For example, selecting the header “instrument” in the instrument column can cause the system to sort the musical ideas according to “including piano”.

In some implementations, the detailed ideas window can include an “import” icon 902, an “export” icon 903, and a “compact ideas” icon 905. The user can select the import icon 902 to import one or more musical ideas from a source other than the musical score (e.g., another musical score). Alternatively, the user can select the export icon 903 to export one or more musical ideas from the current musical score to a different musical score. The user can also select the compact ideas icon 905 to present the compact view of the ideas window (e.g., ideas window 204 of FIG. 2) in the user interface.

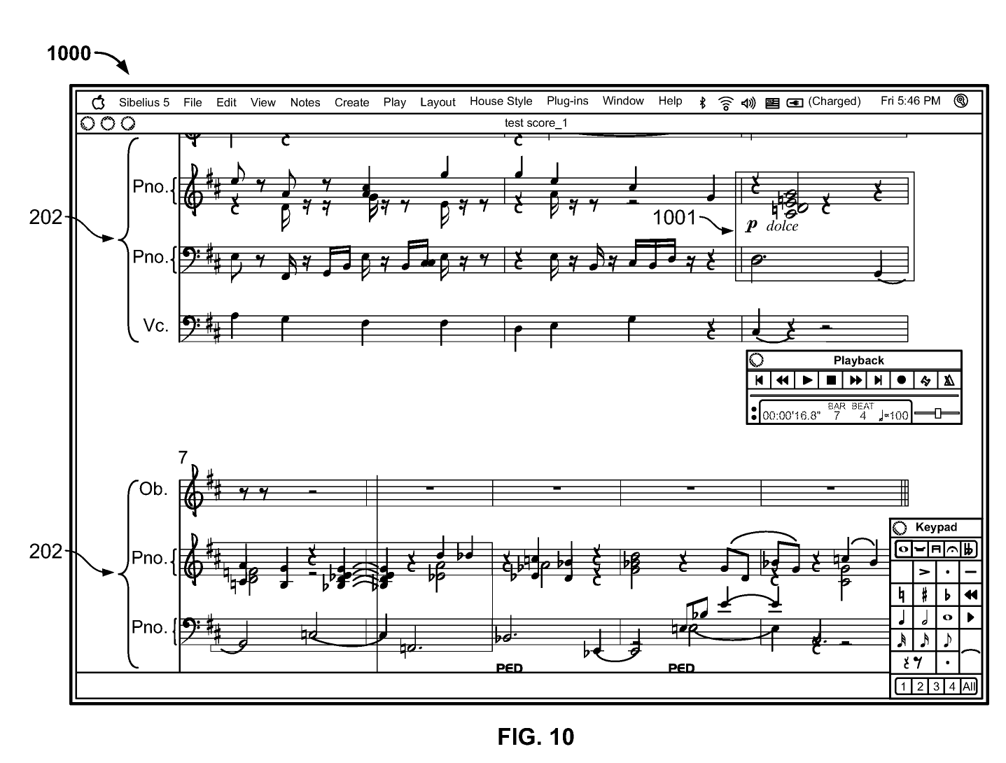

FIG. 10 shows a screenshot 1000 illustrating an example use of the musical idea 901 depicted in FIG. 9. A musical idea can be used within a musical score (e.g., musical score 202). For example, a user can select the musical idea 901 and then select a destination location within the musical score 202 where the musical idea 901 should be placed. In the example shown, the user has placed the musical idea 901 in the musical score 202 beginning at the first beat of the sixth measure of the piano part, shown as inserted musical idea 1001. In this example, placing the musical idea 901 in the piano part modifies the piano part by replacing the existing content of the piano part with the inserted musical idea 1001. Musical idea 1001 modifies the piano part using musical idea 901 for a length equal to the musical idea 901.

In the example shown, the musical score 202 has a different time signature and key signature than the musical idea 901. Thus, placing the musical idea 901 into the musical score 202 can cause the system to transpose the key signature from g minor in the musical idea 901 to d minor in the musical score 202. In some implementations, the system adds accidentals to the musical idea 901 (e.g., “natural” symbols to occurrences of the notes “C” and “F”), to maintain the harmonic structure of the musical idea 901 when it becomes part of the musical score 202. As noted above, in some implementations, after the musical idea 901 is placed into the musical score 202, a transform scale plug in (not shown) can be used to transpose the musical data of the musical idea 901 into the key of the musical score 202 in which the musical idea 901 is placed.

Additionally, placing the musical idea 901 into the musical score 202 can cause the changes to the note values of the musical idea 901 to conform to the meter of the destination location. For example, the time signature for the musical idea 901 is 3/4 (i.e., there are three beats to a measure and the quarter note constitutes one beat). The time signature for the musical score 202 is 4/4 (i.e., there are four beats to a measure and the quarter note constitutes one beat). When the musical idea 901 is placed in the musical score 202, the values and distribution of the notes are changed to conform to the new time signature. For example, measure 6 in the musical score 202 includes the first four beats of the musical idea 901. The first four beats of the musical idea 901 include the entire first measure and the first beat of the second measure.

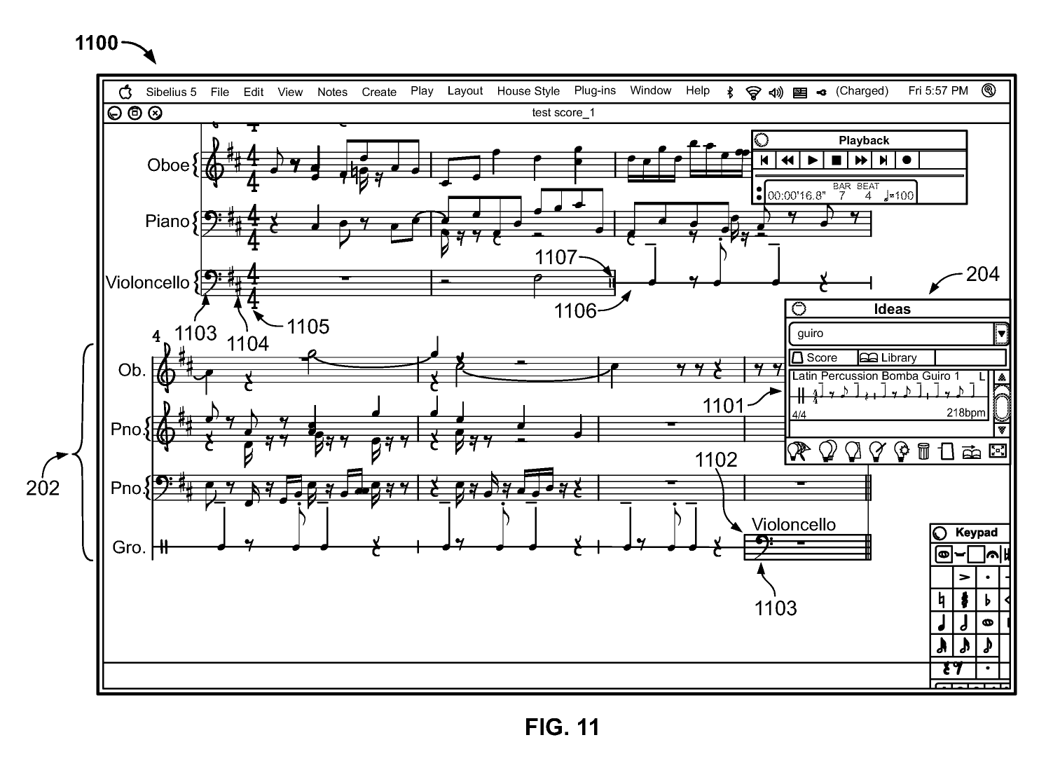

FIG. 11 shows a screenshot 1100 illustrating another example use of a musical idea. In some implementations, placing a musical idea into a musical score causes the system to change a staff and a key signature associated with a location in the musical score where the musical idea is placed. For example, a musical idea can be for a percussion instrument having no melodic aspect. Additionally, some percussion instruments only require a single line staff to indicate rhythmic placement of notes within a measure.

In the example shown, a musical idea 1101 is written for a guiro, which is an un-pitched percussion instrument. The guiro is written on a single line staff. Selecting the musical idea 1101 can cause the system to place the musical idea 1101 into the musical score 202 at a selected location. In the example shown, the musical idea 1101 is placed into a location in the musical score 202 for a violoncello instrument. The violoncello location includes a 5-line/4-space staff 1102, a bass or “F” clef 1103, a key signature 1104, and a time signature 1105. Placing the musical idea 1101 into the musical score 202 causes the 5-line/4-space staff 1102 to become a 1 line staff 1106 and the bass clef 1103 to become a percussion clef 1107. The key signature 1104 does not change until measure 4 (e.g., it is not repeated). The time signature remains the same. In some implementations, a staff can change as needed to facilitate a performance by a single musician on multiple instruments.

In some implementations, the entire musical idea 1101 is placed into the musical score 202. In some implementations, only a portion of the musical idea 1101 is placed into the musical score 202. In some implementations, once the placement of the musical idea 1101 ends, the instrumental part in the location where the musical idea was placed returns to the way it was before placement of the musical idea 1101 (e.g., the 1 line staff 1106 becomes the 5 line/4 space staff 1102, and the percussion clef 1107 becomes the bass clef 1103).

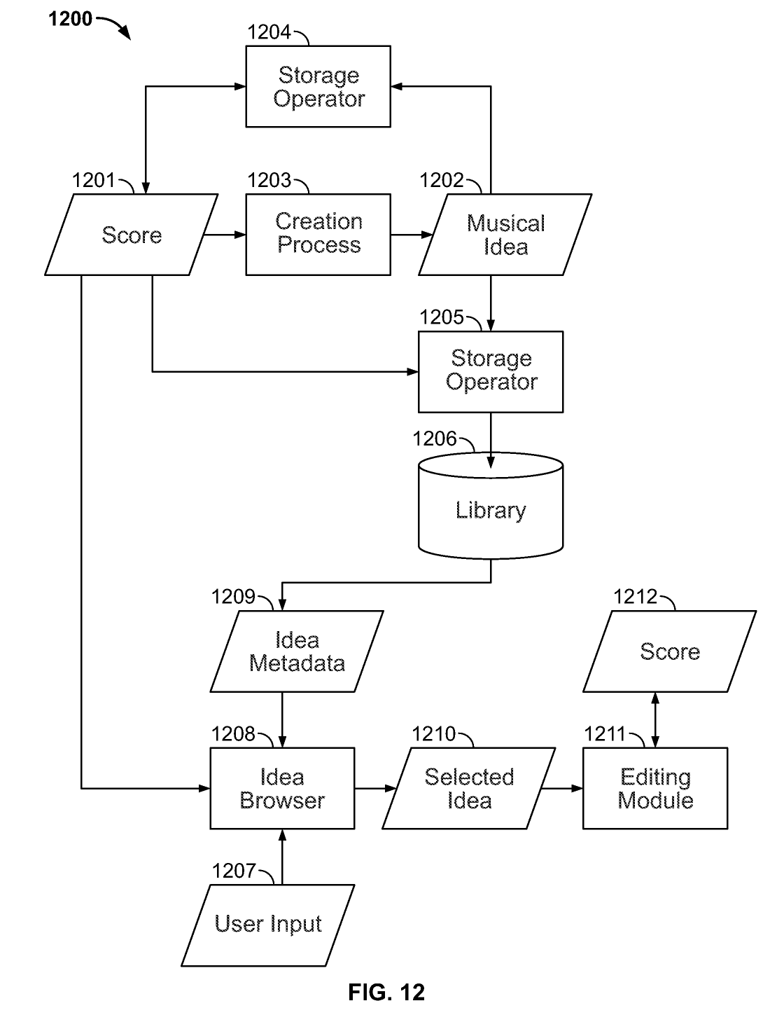

FIG. 12 is a data flow diagram describing an example system 1200 for selecting and using a musical idea. The system 1200 can receive information describing a musical score 1201. The system includes a creation process 1203 that permits a user to create one or more musical ideas 1202 from the musical score 1201 (e.g., as described above with respect to FIGS. 2 and 3). A musical idea 1202 can include musical data corresponding to the musical notes of the musical idea 1202, metadata corresponding to one or more aspects of the musical idea 1202 (e.g., key signature data or tempo data), and graphical data allowing the system to display the musical idea 1202. The system can generate audio data corresponding to a musical idea 1202. The system includes a storage operator 1204 that receives the musical idea 1202 and persistently stores the musical idea 1202 in the musical score 1201 where it was created. The system also includes a storage operator 1205 that receives a musical idea 1202 and persistently stores the musical idea 1202 in a library 1206 apart from the musical score 1201 where it was created.

The system can receive user input 1207, for example through a text box in a graphical user interface, which is provided to an idea browser 1208. Based on the user input, the idea browser 1208 searches the persistently stored musical ideas 1202 (whether in a score or in a library) to identify matching ideas. The musical ideas 1202 can be matched to the user input according to metadata 1209 associated with the musical ideas 1202. The system can present a list of one or more musical ideas 1202 to the user in a user interface, allowing the user to select an idea, again by providing user input (1207). The selected idea 1210 is provided to an editing module 1211 which operates on a musical score 1212. The editing module 1211 permits a user to select a location in the musical score 1212, and in turn places the selected idea 1210 into the musical score at the selected location. Using the graphical data and audio data associated with the musical idea 1202, the system can display and perform the musical score 1212 including the musical idea 1202.

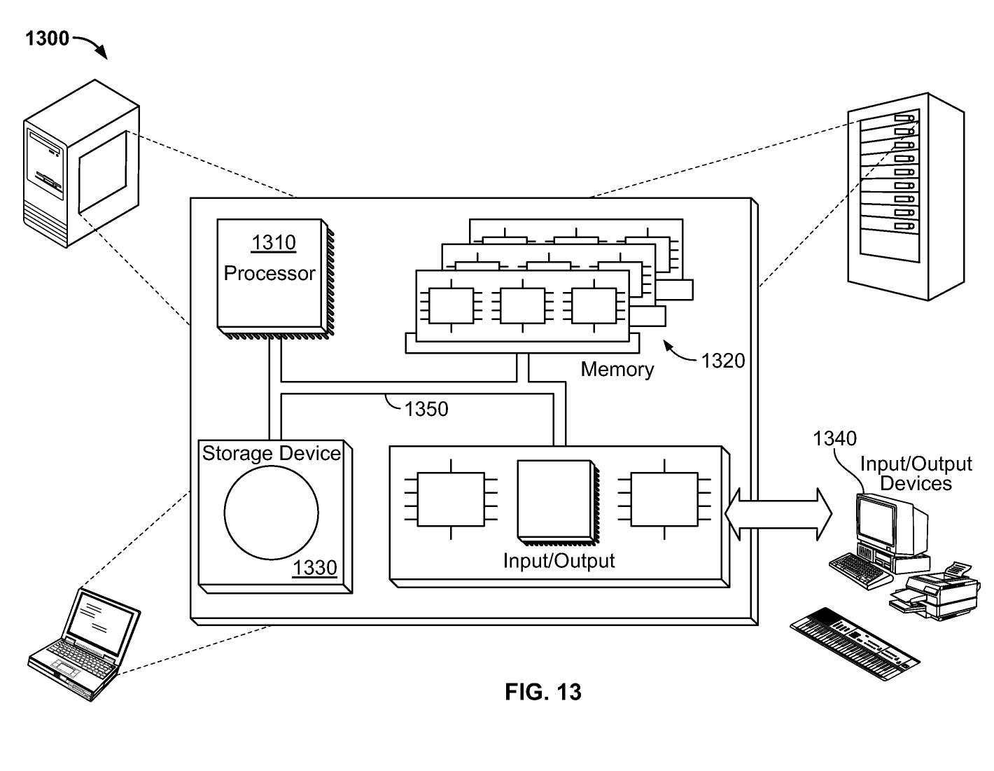

The method described above can be implemented in a computing system. FIG. 13 shows a schematic diagram of an example computer system. The system 1300 can be used for practicing operations described in association with the method 100. The system 1300 can include a processor 1310, a memory 1320, a storage device 1330, and input/output devices 1340. Each of the components 1310, 1320, 1330, and 1340 are interconnected using a system bus 1350. The processor 1310 is capable of processing instructions for execution within the system 1300. In one implementation, the processor 1310 is a single-threaded processor. In another implementation, the processor 1310 is a multi-threaded processor. The processor 1310 is capable of processing instructions stored in the memory 1320 or on the storage device 1330 to display graphical information for a user interface on the input/output device 1340.

The memory 1320 is a computer readable medium such as volatile or non-volatile that stores information within the system 1300. The memory 1320 can store data structures, for example. The storage device 1330 is capable of providing persistent storage for the system 1300. The storage device 1330 may be a floppy disk device, a hard disk device, an optical disk device, or a tape device, or other suitable persistent storage means. The input/output device 1340 provides input/output operations for the system 1300. In one implementation, the input/output device 1340 includes a keyboard and/or pointing device. In another implementation, the input/output device 1340 includes a display unit for displaying graphical user interfaces.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A method comprising:
receiving input selecting a musical phrase, the musical phrase including musical data;
creating a copy of the musical phrase;
persistently storing the copy of the musical phrase;
receiving input selecting a destination location in a musical score;
placing the copy of the persistently stored musical phrase into the musical score at the selected location.

2. The method of claim 1, where the copy of the musical phrase is persistently stored in the musical score.

3. The method of claim 1, where the copy of the musical phrase is persistently stored in a library accessible from more than one distinct musical score.

4. The method of claim 1, where the copy of the musical phrase is viewable in a window apart from the musical score.

5. The method of claim 1, where placing the copy of the musical phrase into the musical score includes automatically transposing the copy of the musical phrase.

6. The method of claim 1, where placing the copy of the musical phrase into the musical score includes automatically adjusting the meter of the copy of the musical phrase.

7. The method of claim 1, further comprising:
capturing and persistently storing metadata and graphical data associated with the musical phrase, where the metadata and graphical data associated with the musical phrase are persistently stored at a source location.

8. The method of claim 7, further comprising:
using the metadata to conform the musical phrase to a destination location, and using the graphical data to display the musical phrase at the destination location.

9. The method of claim 7, where the metadata includes one or more types of information including a name, a key signature, a time signature, an identifier of one or more instruments, and one or more tags.

10. The method of claim 1, where placing the copy of the musical phrase into the musical score includes replacing one or more musical notes in the musical score with the copy of the musical phrase.

11. The method of claim 1, where selecting a musical phrase includes selecting a group of notes for a particular instrument, and wherein placing the copy of the musical phrase into the musical score includes changing a staff in the location in the musical score to correspond to the particular instrument.

12. A computer-readable medium having stored thereon instructions, which, when executed by a processor, causes the processor to perform operations comprising:
generating musical data, the musical data being persistently stored, the musical data including a musical phrase and associated metadata, wherein when the musical data is selected, the musical data is capable of being incorporated into a musical score.

13. The computer-readable medium of claim 12, where the metadata includes one or more types of information including a name, a key signature, a time signature, a list of one or more instruments, and a list of one or more tags.

14. The computer-readable medium of claim 13, where the musical data is incorporated into the musical score in accordance with the associated metadata.

15. The computer-readable medium of claim 12, where incorporating the musical data into the musical score includes automatically transposing the musical data.

16. The computer-readable medium of claim 12, where incorporating the musical data into the musical score includes automatically adjusting the meter of the musical data.

17. A method comprising:
receiving input selecting a musical phrase, the musical phrase including musical data from a first musical score;
creating a copy of the musical phrase;
persistently storing the copy of the musical phrase;
receiving input selecting a destination location in a second musical score;
placing the copy of the persistently stored musical phrase into the second musical score at the selected location.
